(19) United States
(12) Patent Application Publication
(10) Pub. No.: US 2015/0023352 A1
(43) Pub. Date: Jan. 22, 2015

(54) IMPLEMENT EQUAL COST MULTIPLE PATH OF TRILL NETWORK

(71) Applicant: Hangzhou H3C Technologies Co., Ltd., Hangzhou (CN)

(72) Inventors: Xiaopeng Yang, Beijing (CN); Yubing Song, Beijing (CN)

(21) Appl. No.: 14/373,301

(22) PCT Filed: Feb. 7, 2013
(86) PCT No.: PCT/CN2013/071510

§ 371 Date: Jul. 18, 2014

(30) Foreign Application Priority Data
Feb. 8, 2012 (CN) 201210027603.1

(51) Int. Cl. H04L 12/741; H04L 12/931

(52) U.S. Cl. CPC H04L 45/74; H04L 49/351
USPC 370/392

(57) ABSTRACT

According to an example, a method for implementing ECMP in a TRILL network includes: forming a backup group with multiple primary Routing Bridges (RBs) interconnected in the TRILL network; configuring an IP address and a MAC address both associated with each virtual Gateway for each primary RB; configuring a same virtual RB identifier for each primary RB; advertising, by each primary RB, adjacency information about a neighbor RB identifier within the TRILL network; wherein the adjacency information about the neighbor RB identifier includes adjacency information about the virtual RB identifier; enabling a secondary RB accessing a host in the TRILL network to compute and obtain the ECMP information associated with the virtual RB identifier in the TRILL network, in which next hops in the ECMP information associating with the virtual RB identifier are the primary RBs in the backup group are in a one-to-one correspondence.

### BACKGROUND

Transparent Interconnection of Lots of Links (TRILL) is a large-scale Layer 2 network technology standard, which is developed by the Internet Engineering Task Force (IETF).

### BRIEF DESCRIPTIONS OF THE DRAWINGS

Features of the present disclosure are illustrated by way of example and not limited in the following figure(s), in which like numerals indicate like elements, in which:

FIG. 1 is a structure diagram of a network running the TRILL protocol, according to an example.

FIG. 2 is a diagram of a load sharing mode of Layer 3 forwarding for upstream traffic in the network shown in FIG. 1.

FIG. 3 is a diagram of another load sharing mode of Layer 3 forwarding for upstream traffic in the network shown in FIG. 1.

FIG. 4 is a structure diagram of a network, which may implement Equal Cost Multiple Path (ECMP) of a TRILL network, according to an example of the present disclosure.

FIG. 5A is a virtual topology diagram of the TRILL network shown in FIG. 4, according to an example of the present disclosure.

FIG. 5B is a structure diagram of a TRILL encapsulated Address Resolution Protocol (ARP) response packet in the TRILL network shown in FIG. 4, according to an example of the present disclosure.

FIG. 6 is a link failure diagram of a network, which may implement ECMP of a TRILL network, according to an example of the present disclosure.

FIG. 7 is a virtual topology diagram about the TRILL network shown in FIG. 6, according to an example of the present disclosure.

FIG. 8 is a structure diagram of a device, which may implement ECMP of a TRILL network, according to an example of the present disclosure.

FIG. 9 is a structure diagram of another device, which may implement ECMP of a TRILL network, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

The present disclosure relates to network technologies, and more particularly, to a method and device for implementing Equal Cost Multiple Path (ECMP) in a TRILL network.

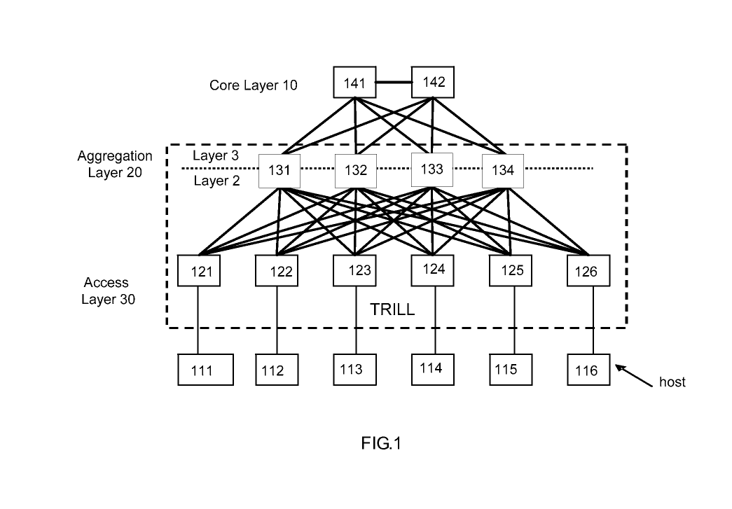

FIG. 1 is a structure diagram of a network running the TRILL protocol, according to an example. The network may consist of a core layer 10, an aggregation layer 20, and an access layer 30. The core layer includes core switches 141 and 142. The aggregation layer includes multiple Routing Bridges (RBridges) 131 to 134. In the following, RBridge is denoted by RB for short. The access layer includes multiple RBs 121 to 126. The RBs in the aggregation layer and access layer form a TRILL network. In the large-scale layer-2 network, RBs in the aggregation layer 20 which share the same virtual IP address are grouped together to form a backup group.

The virtual IP address of the backup group is set on host as the IP address of a gateway (GW). Hosts 111 To 116 may belong to different VLANs (Virtual Local Area Network). For each VLAN, RBs in the aggregation layer 20 may share one virtual IP addresses and form a backup group; the virtual IP addresses shared by RBs are set on hosts 111 to 116 as IP addresses of gateways. RBs in the access layer 30 may access upstream traffic coming from hosts 111 to 116 to the TRILL network, and may send the traffic to one RB of the backup group which the upstream traffic is destined for, so that the RB can implement layer 3 forwarding. The RB in the aggregation layer 20 then performs layer 3 forwarding and sends the upstream traffic to either a host in another VLAN in the large-scale layer 2 network, or to a core switch in core layer 20 for forwarding to outside network. Thus, Load sharing for the above upstream traffic is implemented within the TRILL network.

Technologies of implementing load-sharing for traffics requiring layer 3 forwarding, which are employed by an RB in the aggregation layer of the TRILL network, mainly include the following.

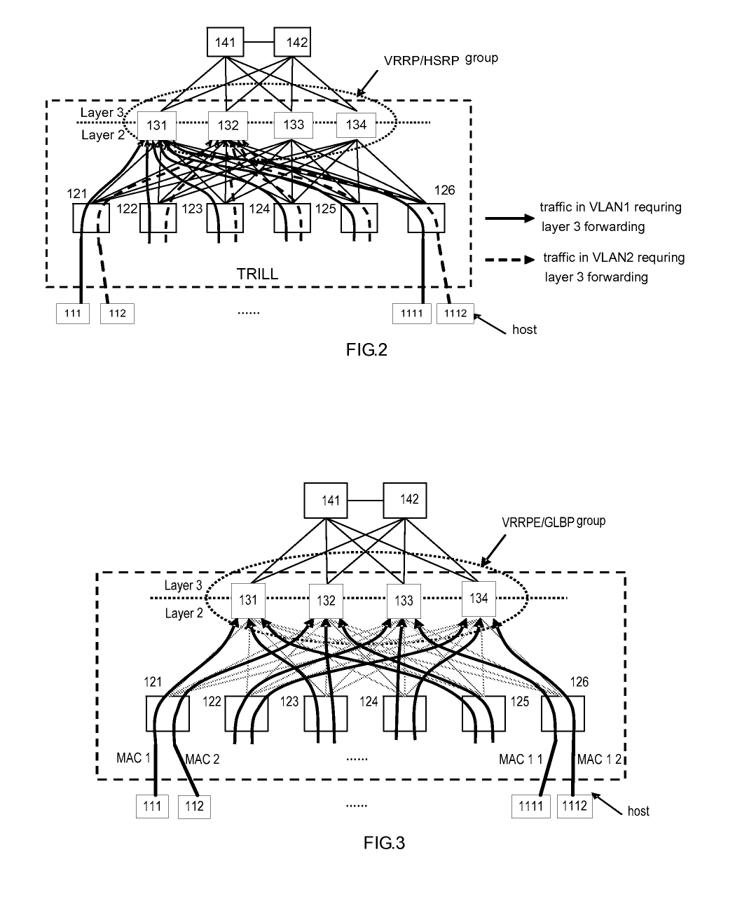

A Backup group formed by multiple RBs in the aggregation layer of a TRILL network could be a Virtual Router Redundancy Protocol (VRRP) backup group, or a Hot Standby Router Protocol (HSRP) backup group. In FIG. 2, Each RB in the access layer of the TRILL network may access upstream traffic requiring layer 3 forwarding in different VLANs to different RBs due to master nodes of different backup groups are different RBs. However, RBs in the access layer of the TRILL network may send traffic requiring layer 3 forwarding in one VLAN to the same RB in the aggregation layer. Thus, in the arrangement of FIG. 2, load sharing is on the basis of VLAN-traffic belonging to a particular VLAN is sent to a particular RB in the aggregation layer. E.g. traffic belonging to VLAN 1 is sent to RB 131, while traffic belonging to VLAN 2 is sent to RB 132. Thus in this arrangement Layer 3 forwarding of upstream traffic belonging to the same VLAN is not shared among different RBs in the aggregation layer.

In a second mode, shown in FIG. 3, the load sharing may be on the basis of the host which the traffic originates from. In this mode, a backup group formed by multiple RBs in the aggregation layer could be a VRRP Enhanced (VRRPE) backup group, or a Gateway Load Balancing Protocol (GLBP) backup group. As shown in FIG. 3, an RB in the access layer may send upstream traffic which belongs to one same VLAN but originates from different hosts to different RBs in the aggregation layer for Layer 3 forwarding. E.g. in one same VLAN, traffic belonging to host 111 is send to RB 131, while traffic belonging to host 112 is send to RB 132. However, in this mode, the Layer 3 forwarding of upstream traffic originated from the same host may not be shared between different RBs.

To achieve multi-path load sharing of Layer 3 traffic in a TRILL network, the following technical solution is put forward by the present disclosure. Form a backup group comprising multiple primary RBs interconnected in a TRILL network. An virtual Internet Protocol (IP) address and a virtual Media Access Controller (MAC) address associated with a virtual GW are shared by all primary RBs in the backup group. Configure one same virtual RB identifier on all primary RBs. Each primary RB in the TRILL network advertises adjacency information associated with neighbor RB identifiers including adjacency information associated with the virtual RB identifier. A secondary RB accessing a host to the TRILL network may be enabled to compute TRILL forwarding information which includes ECMP information associated with the virtual RB identifier. The next-hops of the ECMP information associated with the RB identifier are the primary RBs in the backup group. By taking the primary RBs in the backup group are next-hops of equal cost multi paths of the virtual RB, the secondary RB load-balances traffic sending to the virtual RB for layer-3 forwarding.

Specifically, each primary RB is configured with a unique Nickname. However, one same virtual Nickname may additionally be configured on all of the primary RBs.

Detailed descriptions of examples of the present disclosure will be provided in the following with an example.

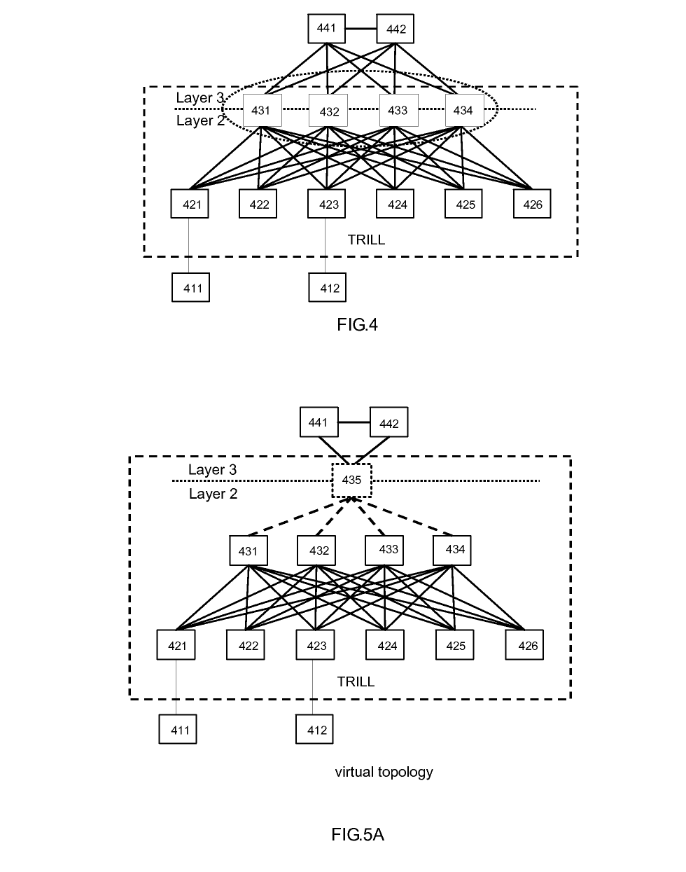

FIG. 4 is a structure diagram of a network, which may implement ECMP of a TRILL network, according to an example of the present disclosure.

The network shown in FIG. 4 may consist of three layers, which are respectively, a core layer, an aggregation layer, and an access layer. The core layer includes core switches 441 and 442. The aggregation layer includes multiple RBs 431 to 434. The access layer includes multiple RBs 421 to 426. A TRILL network is formed by RBs 431 to 434 and RBs 421 to 426. Host 411 in VLAN 1 may access the TRILL network via RB 421. Host 412 in VLAN 2 may access the TRILL network via RB 423.

In the example, RB identifiers of RBs 431 to 434 could be Nicknames of RB 431 to RB 434. RB identifiers of RBs 421 to 426 could be Nicknames of RB 421 to RB 426. RBs 431 to 434 share virtual IP address and virtual MAC address associated with VLAN 1 GW and form a primary backup group; RBs 431 to 434 also are configured with virtual IP address and virtual MAC address associated with VLAN 2 GW and form a Secondary backup group. Due to all RBs are not only members of the primary backup group, but also are members of the primary backup group, the primary backup group and the secondary backup could be deem as one backup group. A virtual RB identifier, such as a Nickname denoted by RB5, may be configured on all members of the backup groups, that is, RBs 431 to 434.

In the example, the virtual RB identifier denotes a Nickname of a virtual non-physical RB in the TRILL network.

The host in the example may be a device, such as a server or a terminal.

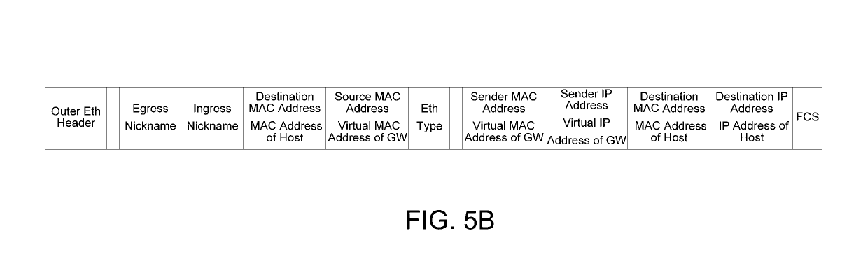

During a running process, each RB in the TRILL network sends a TRILL HELLO message to a neighbor device to confirm its health. Each RB in the TRILL network may also send a Link State Protocol (LSP) data unit to its neighbors. RBs 421 to 426 may advertise adjacency information relating to its physical neighbors. RBs 431 to 434 may advertise adjacency information relating to its physical neighbors and virtual RB identifier. Subsequently, the TRILL network virtual topology shown in FIG. 5A may be obtained. The virtual topology includes a virtual non-physical RB 435.

Each RB in the TRILL network may compute TRILL forwarding information based on the virtual topology of the TRILL network. The TRILL forwarding information computed by each of the RBs 421 to 426 in the access layer includes ECMP information, which is associated with the virtual RB identifier. The next-hops in the ECMP information respectively correspond to each RB in the backup groups. RBs in the backup groups would share upstream traffic which is accessed by an RB in the access layer to the virtual RB for layer 3 forwarding.

In the example, the virtual RB identifier configured on each RB in the backup groups may be a virtual Nickname, which is randomly generated by an master node in the backup group. The virtual Nickname is taken as a virtual RB identifier of a virtual non-physical RB. The virtual Nickname may be sent to other slave nodes via a link between members in the backup groups so as to configure and advertise adjacency information about neighbor RBs, which includes the adjacency information about the virtual Nickname. In the example, the virtual Nickname may be manually configured for each member in the backup groups, that is, RBs 431 to 434.

The load sharing implementation mode about implementing Layer 3 forwarding for upstream traffic in the TRILL network is described in the following, accompanied by the network structure in the TRILL network shown in FIG. 4, which may implement ECMP.

A Layer 3 forwarding process for packet shown in FIG. 4 is taken as an example in the following, in which the data is sent by host 411 in VLAN 1 to host 412 in VLAN 2.

Host 411 request MAC address associating with IP address of GW, which is has been set on the host 411 already and is the virtual IP address shared by members of primary backup group.

1) Host 411 determines that host 411 and host 412 are in different segments, (i.e. different VLANs) based on the IP address of host 412. Host 411 determines that there is no MAC address in the ARP table matching the virtual IP address of GW. Host 411 sends an ARP request message. In the ARP request message, sender MAC address is MAC 411, sender IP address is IP 411, target MAC address is set all 0, Target IP address is IP VLAN 1 (i.e. the virtual IP address of VLAN 1 GW, that is, the virtual IP address shared and configured on the VLAN 1 interfaces on RBs 431 to 434). The source MAC address in the ARP request message is identical to the sender MAC address, the destination MAC address in the ARP request message is set all F.

2) After receiving the ARP request message in VLAN 1, RB 421 may execute the following operations.

RB 421 may learn the MAC address of host 411 based on the ARP request message received.

RB 421 may construct a TRILL header for the received ARP request message. RB 421 may configure its Nickname RB 421 as the Ingress Nickname in the TRILL header. RB 421 may configure a Nickname of an RB, which is taken as the root of multicast tree of the TRILL network, as the Egress Nickname in the TRILL header.

RB 421 may construct an outer Ethernet header. RB 421 may configure its TRILL MAC address (such as TRILL MAC 421) as the source MAC address in the outer Ethernet header. RB 421 may configure the multicast MAC address, such as TRILL MAC address 01-80-C2-00-00-40 of ALL-RBridges, as the destination MAC address in the outer Ethernet header. RB 421 may configure the VLAN ID of the outer Ethernet header. The TRILL MAC address is MAC address of TRILL interface on a RB in a TRILL network. According to related TRILL protocols, source MAC address or destination MAC address in outer Ethernet header should be a TRILL MAC address.

RB 421 broadcasts the ARP request message associated with the virtual IP address of VLAN 1 GW within the TRILL network. All of the RBs in the TRILL network, including RBs 422 to 426 and RBs 431 to 434, may receive the ARP request message associated with the virtual IP address of VLAN 1 GW. In the TRILL network, RB 431, the master node in the primary backup group, responds to the TRILL encapsulated packet associated with virtual IP address of the VLAN 1 GW.

3) After receiving the TRILL encapsulated ARP request message requesting MAC address associating virtual IP address of VLAN 1 GW, RB 431, the master node in the primary backup group may execute the following operations.

RB 431 determines that the destination MAC address in the outer Ethernet header is a multicast address and the Egress Nickname in the TRILL header is a Nickname of an RB, which is taken as the root of a multicast tree. RB 431 remove the outer Ethernet header and TRILL header, and learn the MAC 411 of host 411 based on the ingress nickname in TRILL header and the ARP request message. For example, RB 431 may record MAC 411 and VLAN 1 corresponding to Nickname RB 421 (which is the Ingress nickname in the TRILL header).

RB 431 records a mapping relationship between MAC 411 and IP 411 in the ARP table.

RB 431 generates an ARP reply message, in which sender MAC is MAC VLAN 1 (the virtual MAC address of VLAN 1 interface configured on RB 431), sender IP address is IP VLAN 1 (the virtual IP address of VLAN 1 interface configured on RB 431), target MAC address is MAC 411, target IP address is IP 411; source MAC address is MAC VLAN 1; destination MAC address is MAC 411.

RB 431 constructs a TRILL header for the ARP reply message. RB 431 configures the Nickname RB 421 of RB 421 as the Egress Nickname in the TRILL header according to the destination MAC address in the ARP reply message. RB 431 configures the virtual Nickname RB 5 as the Ingress Nickname in the TRILL header.

RB 431 constructs an outer Ethernet header. RB 431 configures TRILL MAC 421 as the destination MAC address in the outer Ethernet header. RB 431 configures TRILL MAC 431 of RB 431 as the source MAC address in the outer Ethernet header. RB 431 also configures the VLAN ID of the outer Ethernet header. The destination MAC address in outer Ethernet header is a TRILL MAC address of the next-hop of the Egress Nickname.

RB 431 sends the TRILL encapsulated ARP reply message, which carries the outer Ethernet header and the TRILL header, to RB 421. The TRILL encapsulated ARP reply message is shown in FIG.5B.

4) RB 421 receives the TRILL encapsulated ARP reply message and executes the following operations.

RB 421 determines that the destination MAC address in the outer Ethernet header is TRILL MAC 421 of itself and the Egress Nickname in the TRILL header is its Nickname RB 421. RB 421 decapsulates the outer Ethernet header and the TRILL header, and learns the virtual MAC address of VLAN 1 GW based on the TRILL header and the ARP reply message. RB 421 records MAC VLAN 1 and VLAN 1 correspond to RB 5 (which is the Ingress Nickname in the TRILL header).

RB 421 forwards the ARP reply message to host 411, according to the destination MAC address in the ARP reply message.

5) After receiving the ARP reply message, host 411 may execute the following operations.

Host 411 sends an Ethernet frame, which carries an IP packet destined for host 412, to the VLAN 1 GW.

1) Host 411 encapsulates an Ethernet header to the IP packet destined for host 412.

In the TRILL network, the Ethernet header could be deem as an inner Ethernet header, in which the destination MAC is a virtual MAC address of the VLAN 1 GW, the source MAC address is the MAC address of the host 411. The source IP address and the destination IP address in the IP packet are respectively IP 411 and IP 412.

Host 411 forwards the Ethernet frame to RB 421.

2) After receiving the Ethernet frame from host 411, RB 421 may execute the following operations.

RB 421 may construct a TRILL header for the received Ethernet frame. RB 421 may configure its Nickname RB 421 as the Ingress Nickname in the TRILL header. RB 421 may also configure Nickname RB 5 associated with MAC VLAN 1 as the Egress Nickname in the TRILL header. The RB 421 can acquire VLAN ID via the port which an Ethernet frame is received at, and may insert the acquired VLAN ID into the received Ethernet frame.

RB 421 may looks up RB 5, the egress nickname in TRILL header, in the TRILL forwarding information, determines nickname RB 431, nickname RB 432, nickname RB 433, and nickname RB 434 are the four next-hops in the ECMP information associated with RB 5, and selects one nickname as the next-hop from the four next hops, according to a preset load sharing algorithm, such as a hash algorithm. In the example, descriptions are provided in the following, in which RB 421 selects nickname RB 433 as the next-hop according to a preset load balancing algorithm.

RB 421 may construct the outer Ethernet header, wherein, the destination MAC address is TRILL MAC address of TRILL interface on RB 433 (such as TRILL MAC 433), which is the next hop of the Egress Nickname, the source TRILL MAC address is TRILL MAC Address of itself, the VLAN ID is the specify the VLAN ID of a link connecting with the selected next-hop.

RB 421 sends the TRILL frame, which carries the outer Ethernet header and the TRILL header, to RB 433.

Forward a packet to host 412 within VLAN 2.

1) After receiving the TRILL frame, RB 433 decapsulates the outer Ethernet header and the TRILL header in response to a determination that the destination MAC address in the outer Ethernet header is its TRILL MAC address and the Egress Nickname in the TRILL header is the virtual Nickname RB 5. RB 433 may learn the MAC address of host 411 according to the TRILL header and the inner Ethernet header in the Ethernet frame. RB 433 may record MAC 411 and VLAN 1 corresponding to nickname RB 421.

RB 433 implements layer 3 forwarding in response to a determination that the destination MAC address in the inner Ethernet header of the received Ethernet frame is the virtual MAC address of the VLAN 1 GW. RB 433 removes inner Ethernet header and looks up a MAC address mapping to IP 412 of host 412 in the ARP table.

In one example, when determining MAC 412 mapping to IP 412, RB 433 may add/encapsulate the IP packet destined for IP 412, wherein, the destination MAC address is MAC 412 of host 412, the source MAC address is MAC address of VLAN 1 interface configured on RB 433, and the VLAN ID is VLAN 2.
RB 433 constructs the TRILL header for the Ethernet frame, wherein, the Ingress Nickname is Nickname RB 433; the egress Nickname associates with the destination MAC 412 in the inner Ethernet header.
RB 433 constructs an outer Ethernet header for the Ethernet frame, wherein, the source MAC address is TRILL MAC address of RB 433 itself, the destination MAC address is a TRILL MAC address of next-hop of Egress Nickname; the VLAN ID is an VLAN ID specified by a link connecting to next hop of Egress nickname.
When determining nickname of next-hop of the egress nickname is identical to the egress nickname, RB 433 would set a TRILL MAC address corresponding with the egress Nickname as the destination MAC address in outer Ethernet header.
RB 433 sends the TRILL frame to an RB corresponding to destination MAC address in the outer Ethernet header. If the RB receiving the TRILL frame is not the RB configured with the Egress Nickname, it will modify the source MAC address and destination MAC address in the outer Ethernet header. If the RB receive the TRILL frame is the RB configured with the Egress Nickname, it will remove/decapsulate the outer Ethernet header and TRILL header, and sends the Ethernet frame to host 421.

In another example, when RB 433 determines no MAC address mapping to IP 412, RB 433 may generate an ARP request message. In the ARP request message, wherein, sender MAC address is MAC 433 (MAC address of VLAN 2 interface configured on the RB 433), sender IP address is IP 433 (IP address of VLAN 2 interface configured on RB 433); target MAC address is set all 0; target IP address is the IP 412 of the host 412; Ethernet source MAC address is MAC address of RB 433; Ethernet destination MAC address is set all F.

RB 433 constructs a TRILL header for the ARP request message, wherein, the Ingress Nickname is Nickname RB 433, the egress Nickname is a Nickname of root of a multicast tree in the TRILL network.

RB 433 constructs an outer Ethernet header, wherein, source MAC address is TRILL MAC address of RB 433, the destination MAC address is the TRILL multicast MAC address, VLAN ID is specified by a link connecting to next hop of Egress nickname.

Each of the other RBs in the TRILL network may receive the TRILL encapsulated ARP request message broadcasted by RB 433. In the example, processes about RB 423 connecting with the host 412 are mainly described. Processes about decapsulating the outer Ethernet header and the TRILL header by an RB connecting with another host, and processes about broadcasting the ARP request message within VLAN 2 are not repeated here.

2) After receiving the TRILL encapsulated ARP request message, RB 423 may execute the following operations.

RB 423 remove/decapsulates the outer Ethernet header and the TRILL header in response to a determination that the destination MAC address in the outer Ethernet header is the TRILL multicast MAC address and the Egress Nickname in the TRILL header is Nickname of root of a multicast tree, and learn the MAC address of RB 433 according to the TRILL header and the ARP request message, i.e. RB 423 record MAC 433 and VLAN 2 corresponding to Nickname RB 433.

RB 423 broadcasts the ARP request message within VLAN 2.

3) After receiving the ARP request message, host 412 may execute the following operations.

Host 412 records a mapping relationship between MAC 433 and IP 433 in ARP table of itself.

Host 412 generates an ARP reply message, in which sender MAC address is MAC 412 of host 412, sender IP address is IP 412 of host 412, target MAC address is MAC 433, target IP address is IP 433 of RB 433; Ethernet source MAC address is MAC 412 of host 412, Ethernet destination MAC is MAC 433 of RB 433.

Host 412 sends the ARP reply message to RB 423.

4) After receiving the ARP reply message sent by host 412, RB 423 may execute the following operations.

RB 423 learns the MAC address of host 412.

RB 423 adds/encapsulates the received ARP reply message with a TRILL header, wherein, ingress Nickname is its Nickname RB 423, egress nickname is nickname RB 433 corresponding to the destination MAC address in the inner Ethernet header of the ARP reply.

RB 423 adds/encapsulates the received ARP reply message with a outer Ethernet header, wherein, source MAC address is TRILL MAC address of RB 423, destination MAC address is TRILL MAC address of RB 433, VLAN ID is the VLAN ID of a link connecting with the RB corresponding to destination MAC address in the outer Ethernet header.

RB 423 sends the TRILL encapsulated ARP reply message to RB 433.

5) After receiving the TRILL encapsulated ARP reply message, RB 433 executes the following operations.

RB 433 decapsulates the outer Ethernet header and the TRILL header in response to a determination that the destination MAC address in the outer Ethernet header is its Trill MAC address, and the Egress Nickname in the TRILL header is its Nickname, and learns the MAC address of host 412, according to the TRILL header and the ARP reply message, i.e. RB 433 records MAC 412 and VLAN 2 corresponding to nickname RB 423.

RB 433 records a mapping relationship between MAC 412 and IP 412 in the ARP table.

RB 433 adds/ecncapsulates the IP packet destined for IP412 with a new inner Ethernet header, wherein, source MAC address is MAC 433 of RB 433, destination MAC address is MAC 412, the VLAN ID is VLAN 2.

RB 433 constructs the TRILL header and the outer Ethernet header for the Ethernet frame. RB 433 configures Nickname RB 433 of itself as the Ingress Nickname. RB 433 configures RB 423 as the Egress Nickname in the TRILL header corresponding to the destination MAC address in the inner Ethernet header. RB 433 configures the TRILL MAC address of RB 433 itself as the source MAC address in the outer Ethernet header. RB 433 configures TRILL MAC 423 as the destination MAC address in the outer Ethernet header according to the Egress Nickname in the TRILL header. RB 433 configures the VLAN ID in the outer Ethernet header.

RB 433 sends the TRILL frame to RB 423.

6) RB 423 removes the outer Ethernet header and the TRILL header from the TRILL frame, and sends the Ethernet frame to host 412.

In the example, processes regarding sending an IP packet to host 411 by host 412 are similar to processes regarding sending an IP packet to host 412 by host 411. Host 412 sends the ARP request message to request for the virtual MAC address of VLAN 2 GW. RB 423 encapsulates the TRILL header and the outer Ethernet header for the ARP request message, which is requested virtual MAC address associated with virtual the IP address about the VLAN 2 GW. RB 423 broadcasts the TRILL encapsulated ARP request message within the TRILL network.

RB 431, which is taken as master node in the backup group, responds to the ARP request message associated with the virtual IP address of the VLAN 2 GW, and generates an ARP reply message. RB 431 encapsulates a TRILL header and an outer Ethernet header to the ARP reply message, in which the Ingress Nickname in the TRILL header is virtual Nickname RB 5. RB 423 learns the virtual MAC address of VLAN 2 GW, according to the Ingress Nickname in the TRILL header and the ARP reply message. RB 423 removes the outer Ethernet header and the TRILL header, and sends the ARP reply message to host 412.

Host 412 encapsulates an inner Ethernet header to the IP packet destined for host 411. The destination MAC address in the inner Ethernet header is the virtual MAC address of the VLAN 2 GW. After receiving the Ethernet frame, RB 423 selects a next-hop from four next hops in the ECMP information associated with RB 5, such as RB 434, according to the virtual Nickname RB 5 associated with the virtual MAC address of the VLAN 2 GW. RB 423 constructs a TRILL header and an outer Ethernet header for the received Ethernet frame. RB 423 configures Nickname RB 423 as the Ingress Nickname in the TRILL header and configures Nickname RB 5 as the Egress Nickname. RB 423 configures TRILL MAC address 423 as the source MAC address in the outer Ethernet header and TRILL MAC address 434 as the destination MAC address in the outer Ethernet header. RB 423 configures the VLAN ID in the outer Ethernet header. RB 423 sends the TRILL frame to RB 434. RB 434 decapsulates the outer Ethernet header and the TRILL header, removes inner Ethernet header, adds a new inner Ethernet header, a new TRILL header and a new outer Ethernet header, sends a TRILL frame to RB 411. RB 411 removes the outer Ethernet header and TRILL header, sends the Ethernet packet to host 411.

In the example, any of RBs 431 to 434 in the aggregation layer stays in the backup groups and advertises adjacency information of physical neighbor RBs in the TRILL network with the LSP in response to a detection that all its physical uplinks (that is, the physical connection between itself and core switches 441, 442). That is, RBs in the aggregation layer will not advertise adjacency information associated with the virtual RB identifier, if their uplinks are disconnected. The virtual topology relationship obtained by RBs 421 to 426 in the access layer changes. RBs 421 to 426 may compute the TRILL forwarding information in the TRILL network once again. RBs 421 to 426 may obtain a new ECMP information associated with virtual RB identifier after computing once again.

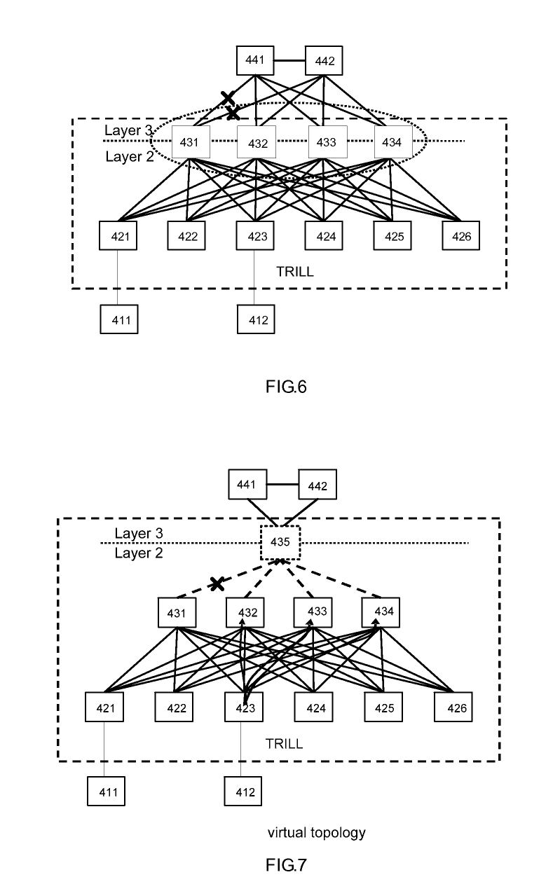

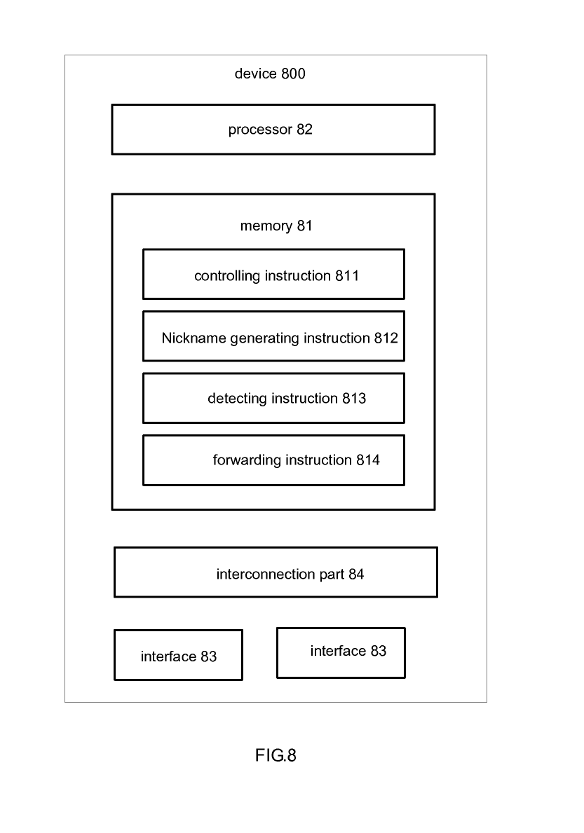

As shown in FIG. 6, in the network structure, which may implement ECMP in the TRILL network, RB 431 in the backup groups detects its two uplinks connecting with core switches 441 and 442 are disconnected, remains in the backup groups as the master node, and advertise adjacency information associated with physical neighbor RBs with the LSP. FIG. 7 is a virtual topology about the TRILL network with two links broken down shown in FIG. 6. RBs 432 to 434 advertise adjacency information about a neighbor RB identifier with the LSP. The adjacency information about the neighbor RB identifier includes adjacency information about the virtual RB identifier. The TRILL forwarding information re-computed by RBs 421 to 426 includes the ECMP information associated with the virtual RB identifier. The ECMP information includes three next hops, which respectively correspond to RB 432, RB 433, and RB 434. Thus, in the TRILL network, RBs 432 to 434 load-share Layer 3 forwarding for the upstream traffics accessed from RBs 421 to 426.

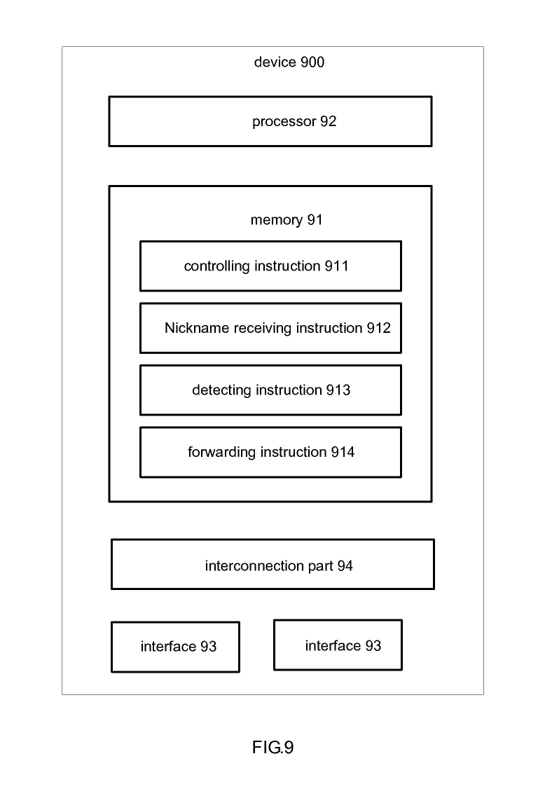

FIG. 8 is a structure diagram of a device, which may implement ECMP in a TRILL network, according to an example of the present disclosure. Device 800 is applied to a master RB in a backup group. The device at least includes a memory 81, a processor 82 in communication with the memory 81, multiple interfaces 83, and interconnection part 84. The memory 81 stores a controlling instruction 811 and a Nickname generating instruction 812, both of which are executable by the processor 82. Interconnection part 84 is to couple the memory 81 and multiple interfaces 83.

Nickname generating instruction 812 indicates that a virtual RB identifier is to be generated and that the generated virtual RB identifier is to be sent via the multiple interfaces.

Controlling instruction 811 indicates that a backup group is to be formed with other RBs interconnected, an virtual IP address and a virtual MAC address both associated with each virtual GW are to be configured, a virtual RB identifier is to be configured, and adjacency information of neighbor RB identifiers is to be advertised in the TRILL network via interface 83. The adjacency information of the neighbor RB identifiers includes adjacency information about the virtual RB identifier.

Controlling instruction 811 may further include an ARP processing instruction 8111 (which is not shown in the Figure). ARP processing instruction 8111 may indicate that an ARP request message requesting virtual MAC address associated with virtual IP address of a virtual GW is to be received via interface 83, in which the ARP request message is encapsulated with an outer Ethernet header and a TRILL header. ARP processing instruction 8111 may indicate that the outer Ethernet header and the TRILL header of the ARP request message are to be decapsulated, a corresponding ARP reply message is to be generated, an outer Ethernet header and a TRILL header are to be encapsulated to the ARP reply message, and send the encapsulated ARP reply message via interface 83. The Ingress Nickname in the TRILL header of the ARP reply message is a virtual RB identifier.

Memory 81 may further store a detecting instruction 813 and a forwarding instruction 814, both of which are executable by the processor 82.

Detecting instruction 813 indicates that a physical connection to a core switch is to be detected and detected state is to be fed back. Controlling instruction 811 further indicates that a determination is to be made that all of the physical connections to the core switch are disconnected, according to state about the physical connection to the core switch detected according to detecting instruction 813. Controlling instruction 811 further indicates that adjacency information associated with a neighbor RB identifier is to be advertised via interface 83. The adjacency information associated with the neighbor RB identifiers excluding adjacency information associated with the virtual RB identifier.

Forwarding instruction 814 indicates that the Ethernet frame encapsulated with an outer Ethernet header and a TRILL header is to be received via interface 83, the outer Ethernet header having its TRILL MAC address as destination MAC address is to be removed, the TRILL header having the virtual RB identifier as egress nickname is to be removed, the inner Ethernet header having the virtual MAC address of the virtual GW as destination MAC address is to be removed, and layer 3 forwarding is to be performed based on destination IP address in the IP header.

FIG. 9 is a structure diagram of another device, which may implement ECMP in a TRILL network, according to an example of the present disclosure. Device 900 is applied to a slave RB in a backup group. The device at least includes a memory 91, a processor 92 in communication with the memory 91, multiple interfaces 93, and interconnection part 94. The memory 91 stores controlling instruction 911 and Nickname receiving instruction 912, both of which are executable by the processor 92. The interconnection part 94 couples to the memory 91 and multiple interfaces 93.

The Nickname receiving instruction 912 indicates that a virtual RB identifier is to be received via one interface.

Controlling instruction 911 indicates that a backup group is to be formed with other RBs interconnected, an virtual IP address and a virtual MAC address both associated of one GW are to be configured, a virtual RB identifier is to be configured, adjacency information associated with a neighbor RB identifiers is to be advertised in the TRILL network via the interface 93. The adjacency information associated with the neighbor RB identifiers includes adjacency information associated with the virtual RB identifier.

Controlling instruction 911 may further include an ARP processing instruction 9111 (which is not shown in the Figure). The ARP processing instruction 9111 may indicate that an ARP request message requesting virtual MAC address associated with the virtual IP address of the virtual GW is to be received, in which the encapsulated ARP request message is encapsulated with an outer Ethernet header and a TRILL header, and that the encapsulated ARP request message requesting MAC address associated with the IP address of the virtual GW is to be discarded or not processed.

The memory 91 may further store detecting instruction 913 and forwarding instruction 914, both of which are executable by the processor 92.

Detecting instruction 913 indicates that the state of a physical connection to a core switch is to be detected and that the state detected is to be fed back.

Controlling instruction 911 further indicates that a determination is to be made that all of the physical connections to the core switch are disconnected, according to the state about the physical connection to the core switch fed back based on detecting instruction 913, and adjacency information associated with neighbor RB identifier is to be advertised via interface 93. The adjacency information about the neighbor RB identifier doesn't include adjacency information associated with the virtual RB identifier.

Forwarding instruction 914 indicates that the Ethernet frame encapsulated with an outer Ethernet header and a TRILL header is to be received via interface 93, the out Ethernet header having its TRILL MAC address as destination MAC address is to be removed, the TRILL header having the virtual RB identifier as egress nickname is to be removed, the inner Ethernet header having virtual MAC address of the virtual GW as destination MAC address is to be removed, layer 3 forwarding based on destination IP address is performed.

In the above example of the present disclosure, adjacency information about a neighbor RB identifier may be respectively advertised in a TRILL network by each RB in a backup group. The adjacency information about a neighbor RB identifier includes adjacency information about a virtual RB identifier.

According to an example, an RB in the access layer of the TRILL network computes ECMP information associated with the virtual RB identifier to enable each RB in the backup groups to be taken as a next hop in the ECMP information destined for the virtual RB from an RB of the access layer. Thus, load sharing of upstream Layer 3 traffic destined for the virtual RB sent by an RB in the access layer may be implemented.

What is claimed is:

1. A method for implementing Equal Cost Multiple Path (ECMP) in a Transparent Interconnection of Lots of Links (TRILL) network, comprising:
forming a backup group comprising multiple primary Routing Bridges (RBs) interconnected in the TRILL network;
for each primary RB, configuring an virtual Internet Protocol (IP) address and a virtual Media Access Control (MAC) address, wherein the virtual IP address and the virtual MAC address are associated with a virtual Gateway (GW);
configuring a same virtual RB identifier for each primary RB;
advertising, by each primary RB, adjacency information about a neighbor RB identifier within the TRILL network, wherein the adjacency information about the neighbor RB identifier comprises adjacency information about the virtual RB identifier;
enabling a secondary RB accessing a host in the TRILL network to compute and obtain the ECMP information associated with the virtual RB identifier, wherein next hops in the ECMP information are the primary RBs in the backup group.

2. The method according to claim 1, further comprising:
receiving, by each primary RB in the backup group, an Address Resolution Protocol (ARP) request message broadcasted by the secondary RB and associated with the virtual IP address of a virtual GW, wherein the ARP request message is encapsulated with an outer Ethernet header and a TRILL header;
decapsulating, by the primary RB acting as a master node in the backup group, the outer Ethernet header and the TRILL header for the ARP request message;
generating a corresponding ARP reply message;
encapsulating the outer Ethernet header and the TRILL header for the ARP reply message, wherein an Ingress Nickname in the TRILL header of the ARP reply message is the virtual RB identifier;
sending, by the primary RB acting as the master node in the backup group, the ARP reply message encapsulated to the secondary RB, which accesses the ARP request message, to enable the secondary RB to record a mapping relationship between the virtual MAC address relating to the virtual GW in the ARP reply message and the virtual RB identifier in the TRILL header of the ARP reply message.

3. The method according to claim 1, further comprising:
receiving, by a primary RB in the backup group, an Ethernet frame encapsulated with the outer Ethernet header and the TRILL header, which is accessed by the secondary RB,
wherein an Egress Nickname of the TRILL header in the Ethernet frame is the virtual RB identifier, the primary RB that receives the Ethernet frame encapsulated is a next hop selected by the secondary RB according to the ECMP information about the virtual RB identifier mapped by the destination MAC address in the Ethernet frame; and
decapsulating, by the primary RB that receives the encapsulated Ethernet frame, the outer Ethernet header having its TRILL MAC address as destination MAC address, the TRILL header having the virtual RB identifier as egress nickname and the inner Ethernet header having the virtual MAC address of the virtual GW as destination MAC address, and forwarding correspondingly according to the destination IP address.

4. The method according to claim 1, further comprising:
detecting, by each primary RB, a physical connection to a core switch;
when determining that all of the physical connections to the core switch are disconnected, advertising, by the primary RB, the adjacency information about the neighbor RB identifier that excludes the adjacency information about the virtual RB identifier to enable the secondary RB to remove the primary RB from next hops in the ECMP information associated with the virtual RB identifier.

5. A device capable of acting as a master Routing Bridge (RB) in a Transparent Interconnection of Lots of Links (TRILL) network, the device at least comprises a memory, a processor in communication with the memory, multiple interfaces and an interconnection part, the memory stores a Nickname generating instruction and a controlling instruction, both of which are executable by the processor, the interconnection part is to couple the memory and the multiple interfaces,
the Nickname generating instruction is an instruction to generate a virtual RB identifier, and send the generated virtual RB identifier via the multiple interfaces; and
the controlling instruction is an instruction to form a backup group together with other RBs, and to configure an virtual Internet Protocol (IP) address and a virtual Media Access Control (MAC) address associated with a virtual Gateway (GW), configure a virtual RB identifier, advertise adjacency information about a neighbor RB identifier within the TRILL network via the multiple interfaces, wherein the adjacency information about the neighbor RB identifier comprises adjacency information about the virtual RB identifier.

6. The device according to claim 5, wherein the memory further stores a detecting instruction executable by the processor, which indicates that a physical connection to a core switch is to be detected and that the detected state is to be fed back; and
the controlling instruction further indicates that a determination is to be made that all of the physical connections to the core switch are disconnected, taking into account the state about the physical connection to the core switch fed back based on the detecting instruction, the adjacency information about the neighbor RB identifier that excludes the adjacency information about the virtual RB identifier is to be advertised via the multiple interfaces.

7. The device according to claim 5, wherein the memory further stores a forwarding instruction executable by the processor,
the forwarding instruction indicates that an Ethernet frame encapsulated with an outer Ethernet header and a TRILL header is to be received via the multiple interfaces, the outer Ethernet header having its TRILL MAC address as destination MAC address is to be removed, the TRILL header having the virtual RB identifier as egress nickname is to be removed, the inner Ethernet header having the virtual MAC address of the virtual GW as destination MAC address is to be removed, and layer 3 forwarding is to be performed based on destination IP address.

8. The device according to claim 5, wherein the controlling instruction further comprises an Address Resolution Protocol (ARP) processing instruction, which indicates that an ARP request message associated with an IP address of a virtual GW is to be received via the multiple interfaces, wherein the ARP request message is encapsulated with an outer Ethernet header and a TRILL header, the outer Ethernet header and the TRILL header of the ARP request message are to be decapsulated, a corresponding ARP reply message is to be generated, the outer Ethernet header and the TRILL header for the ARP reply message are to be encapsulated, and the ARP reply message encapsulated via the multiple interfaces is to be sent, wherein an Ingress Nickname in the TRILL header of the ARP reply message is the virtual RB identifier.

9. A device for implementing Equal Cost Multiple Path (ECMP) in a Transparent Interconnection of Lots of Links (TRILL) network, which is applied to a slave Routing Bridge (RB) in a backup group, wherein the device at least comprises a memory, a processor in communication with the memory, multiple interfaces and an interconnection part, the memory stores a Nickname receiving instruction and a controlling instruction, both of which are executable by the processor, the interconnection part is to couple the memory and the multiple interfaces, wherein
the Nickname receiving instruction indicates that a virtual RB identifier is to be received via the multiple interfaces; and
the controlling instruction indicates that the backup group is to be formed with other RBs interconnected, an Internet Protocol (IP) address and a Media Access Control (MAC) address both associated with each virtual Gateway (GW) are to be configured, adjacency information about a neighbor RB identifier within the TRILL network is to be advertised via the multiple interfaces, wherein the adjacency information about the neighbor RB identifier comprises adjacency information about the virtual RB identifier.

10. The device according to claim 9, wherein the controlling instruction further indicates that an Address Resolution Protocol (ARP) request message associated with an IP address of a virtual GW are to be received via the multiple interfaces, wherein the ARP request message is encapsulated with an outer Ethernet header and a TRILL header, and that the ARP request message associated with the IP address of the virtual GW.

11. The device according to claim 9, wherein the memory further stores a detecting instruction executable by the processor, which indicates that a physical connection to a core switch is to be detected and that the detected state is to be fed back; and
the controlling instruction further indicates that a determination is to be made that all of the physical connections to the core switch are disconnected, according to the state about the physical connection to the core switch fed back according to the detecting instruction, and that adjacency information about a neighbor RB identifier that excludes the adjacency information about the virtual RB identifier is to be advertised via the multiple interfaces.

12. The device according to claim 9, wherein the memory further stores a forwarding instruction executable by the processor,
the forwarding instruction indicates that an Ethernet frame encapsulated with an outer Ethernet header and a TRILL header with the multiple interfaces is to be received, the outer Ethernet header having its TRILL MAC address as destination MAC address is to be removed, the TRILL header having the virtual RB identifier as egress nickname is to be removed, the inner Ethernet header having MAC address of the virtual GW as destination MAC address is to be removed, and layer 3 forwarding is to be performed based on an destination IP address;
